(19) United States
(12) Patent Application Publication
(10) Pub. No.: US 2014/0207794 A1
(43) Pub. Date: Jul. 24, 2014

(54) METHOD AND APPARATUS FOR CONDUCTING A SEARCH BASED ON CONTEXT

(71) Applicants: Nan Du, Beijing (CN); Hao Wang, Beijing (CN)

(72) Inventors: Nan Du, Beijing (CN); Hao Wang, Beijing (CN)

(73) Assignee: NOKIA CORPORATION, Espoo (FI)

(21) Appl. No.: 13/819,607

(22) PCT Filed: Aug. 30, 2010
(86) PCT No.: PCT/CN2010/076457

§ 371 Date: Feb. 16, 2014

(51) Int. Cl. G06F 17/30

(52) U.S. Cl. CPC G06F 17/30545
USPC 707/748

(57) ABSTRACT

An approach is provided for enabling a search to be performed based on the context of the requesting user. A query processing platform receives a query from a user at a device. The platform then determines to select and then transmit the query to one or more other users based on context information associated with the user or the device, a relevancy of the one or more other users to the query, or a combination thereof.

### BACKGROUND OF THE INVENTION

Manufacturers of devices such as mobile phones, Smartphone's and the like are continually challenged to deliver value and convenience to consumers by, for example, providing compelling network services that are accessible from the device. Increasingly, these network services provide easy access to a vast library of online and offline information resources, including web pages, online databases, local databases, services, applications, etc. When conducting an information search, the sheer volume and scope of available information can quickly overwhelm many device users. Furthermore, the sources providing the information may not be as well known or trusted by the user, especially for inquiries of a more personal or social nature. Consequently, many users seek out information from well known and reliable sources, such as friends, family members or colleagues by way of a social network. Typically, the information search is conducted in the form of a query that is directed to the individual or groups thereof deemed most capable or trusted to respond. Device users can readily submit queries and engage with members of their social network directly through their wireless communication device, even while on-the-go. However, most information searches performed by way of a social networking service do not account for the context of the user or user device at the moment of inquiry, which is often quite relevant to generating the best response.

### SUMMARY OF THE INVENTION

Therefore, there is a need for an approach for enabling an information search to be performed based on the context of the requesting user.

According to one embodiment, a method comprises receiving a query from a user at a device. The method also comprises determining to select one or more other users based, at least in part, on context information associated with the user or the device, a relevancy of the one or more other users to the query, or a combination thereof. The method further comprises determining to transmit the query to respective devices of the one or more other users.

According to another embodiment, an apparatus comprising at least one processor, and at least one memory including computer program code, the at least one memory and the computer program code configured to, with the at least one processor, cause, at least in part, the apparatus to receive a query from a user at a device. The apparatus is also caused to determine to select one or more other users based, at least in part, on context information associated with the user or the device, a relevancy of the one or more other users to the query, or a combination thereof. The apparatus is further caused to determine to present the one or more responses based, at least in part, on the rating.

According to another embodiment, a computer-readable storage medium carrying one or more sequences of one or more instructions which, when executed by one or more processors, cause, at least in part, an apparatus to receive a query from a user at a device. The apparatus is also caused to determine to select one or more other users based, at least in part, on context information associated with the user or the device, a relevancy of the one or more other users to the query, or a combination thereof. The apparatus is further caused to determine to transmit the query to respective devices of the one or more other users.

According to another embodiment, an apparatus comprises means for receiving a query from a user at a device. The apparatus also comprises means for determining to select one or more other users based, at least in part, on context information associated with the user or the device, a relevancy of the one or more other users to the query, or a combination thereof. The apparatus further comprises means for determining to transmit the query to respective devices of the one or more other users.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling an information search to be performed based on the context of the requesting user, according to one embodiment;

FIG. 2 is a diagram of a query processing platform for enabling an information search to be performed based on the context of the requesting user, according to one embodiment;

FIG. 3 is a diagram of a workflow for responding to, forwarding or caching an information search request submitted by a user, according to one embodiment;

FIGS. 4 and 5 are flowcharts of a process for enabling an information search to be performed based on the context of the requesting user, according to various embodiments;

FIGS. 6A and 6B are diagrams of interactions between a client and a server utilized in data mining included in the processes of FIGS. 4 and 5, according to various embodiments;

FIGS. 7A-7C are diagrams of user interfaces of a device utilized in the processes of FIGS. 4 and 5, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DETAILED DESCRIPTION OF EMBODIMENTS OF THE INVENTION

Examples of a method, apparatus, and computer program for enabling an information search to be performed based on the context of the requesting user are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form to avoid unnecessarily obscuring the embodiments of the invention. Although various embodiments are described with respect to a mobile device, it is contemplated that the approach described herein may be used with any other device that renders information to a user by way of a display mechanism.

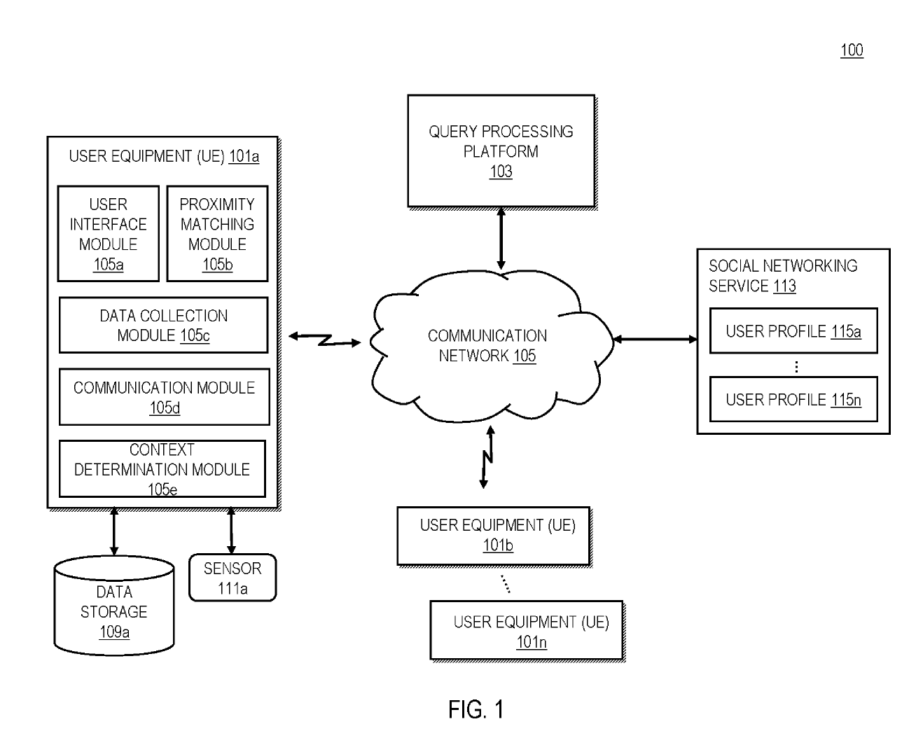

FIG. 1 is a diagram of a system for enabling an information search to be performed based on the context of the requesting user, according to one embodiment. By way of example, the system 100 enables a device 101a user to publish or submit queries to other device 101b-n users via a query processing platform 103. The other device users may be associated with the user that published the query in various ways, including mutual affiliation with a particular contact list or group, common social network or online community membership. In certain embodiments, the other users may be associated with the user that submitted the query by indicating, announcing or submitting to the user their profile information, which provides data, attributes or characteristics that align with the user's interests for fulfillment of the query. Whether associated with the user that initiates the information search by way of a common group, i.e., social network, or by way of exhibiting characteristics that match the query, system 100 enables the context of the user or user device 101a to engage the query process with other user devices 101b-n, unlike traditional information search systems.

For example, it is noted that people typically have more confidence in the suggestions, facts or other information provided to them by family, friends and acquaintances. Rather than rely strictly upon online information resources and search tools, users can also elicit feedback and advice regarding specific inquiries directly from their virtual network of contacts. However, only searching for information among one's immediate contacts can sometimes constrain and narrow down the field of inquiry, especially when the characteristics for a network of contacts are not relative to the context of the user or the question. Still further, even when there is relevancy between the query and the capacity for contacts within the user's network to address it, most information systems neglect to consider the credibility of the search results that are produced. Therefore, information search systems do not typically enable trust-based information propagation, question-matching and user context awareness for rendering real-time responses to user queries.

To address this issue and provide such features, system 100 of FIG. 1 enables a user of user equipment (UE) 101a to submit a query to other users of user equipment (UE) 101b-101n by way of access to a query processing platform 103. Of particular note, the query processing platform 103 intelligently directs (or recommends the directing of) queries received at a user device to other users, such as based on criteria relevant to the one or more users, a profile or trust level of the one or more users a trust level associated with the query, or any other data for taking context into consideration. The query processing platform 103 also provides a medium through which the multiple other users of UE 101b-n can coordinate presentment of their responses to the requesting user, the responses being rated accordingly. Access to the query processing platform 103 by the one or more UE 101a-n is enabled by a communication network 105. In certain embodiments, the query processing platform 103 is implemented as a collection of a hardware, software, firmware or combinations thereof that can be integrated for use with a social networking service 113 accessible by UEs 101a-n. By way of example, the query processing platform 103 can be maintained on a server, while operating in connection with the social networking service 113 as a webservice, applet, script, object-oriented application or the like for enabling search processing to be performed directly from one or more devices. In this way, the query processing platform 103 and social networking service 113 may present a common, integrated interface, through which queries may be submitted, responses reviewed, etc. It is noted that the query processing platform 103 may be implemented as an extensible feature of the social networking service 113, while in some instances, may be implemented as a separate service.

In certain embodiments, the other users that operate respective UE 101b-n can be associated with the user of UE 101a through the social networking service 113. In this scenario, the user of UE 101a may be registered with the social networking service 113 as a member, maintaining a distinct user profile 115a. Likewise, users of respective UEs 101b-n also maintain profiles, e.g., profile 115n. The profiles 115a-n may be data files containing profile information for distinctly specifying, classifying and/or identifying users. Profile information may include the user's name, age, address, phone number, e-mail address, occupation, hobbies, interests, organizational affiliations, activities of engagement, etc. The profile information may also establish linkages the user shares with others within the context of the social network 113 such as virtual group affiliations, personal contacts, friendships, online communities and interest groups, and past communication exchanges with other members (e.g., threaded messages). Still further, communication settings, data access restrictions, communication protocols, query processing platform 103 settings, etc., may also be indicated in the user profile 115. The social networking service 113 provides a common interface that enables users to interact with one another to establish friendships, communicate, access common applications and features, identify friends-of-friends, share files, etc. It is noted that the user profile 115a-n can be optionally maintained within data storage 109a of respective UE 101a-n for facilitating a social networking session with other users through the service 113.

In certain embodiments, the other users that operate respective UE 101b-n are associated with the user of UE 101a based on a detected commonality in context between the devices or users thereof relative to the inquiry being submitted to the query processing platform 103. “Context,” in certain embodiments, refers to the extent of relevancy, associated trust level or matching of a particular user of UE 101 to a particular query posed by a user. By way of example, suppose a particular device user poses a query to other members of the social networking service 113. The user submits a question and/or statement for the purpose of inquiry: “Does anyone know of a good travel agent? I'd like to travel to Egypt.” As submitted, the query is presented in question and statement form, and contains various keywords, such as “travel agent,” “travel” and “Egypt,” all of which can be used as context information for identifying one or more other users related to the query. If one of the other users to which the requesting user is associated has recently traveled to Northern Africa, is a travel agent by occupation, is a member of a travel club, or has others within their network having characteristics that align with the keywords; if this information is specified in that user's profile, the affinity between the question and the detected characteristics of the user provides an indication of “contextual” suitability for enabling that user to address the query.

In certain embodiments, a query may also be submitted along with an indication of a user preferred trust level or requirement. By way of example, when the query is directed towards fulfilling an inquiry, obtaining advice or guidance, performing research, etc. (as in the question regarding Egypt above), the user may assign a low level of trust to the query so that the query processing platform 103 can perform a direct matching between the query and the profiles of as many other users as many as possible. Under this scenario, the query is directed to all potential responders for the purpose of yielding general information/advice. By contrast, there are instances where the query is directed towards asking an opinion, asking for feedback, asking for help or requesting a favor. For instance, the user may submit a query for asking a favor: “I have to go travelling for two weeks. Can anyone help me to take care of my dog?” Under this scenario, the context of the request is not simply investigative or inquisitive in nature, but rather, indicates a favor or other request regarding a high level of trust between the user submitting the query and a potential respondent. The user may submit the query along with an indication that the query requires a high-trust candidate for responding. It is noted that this approach effectively limits the number of potential recipients of the query to only those users categorized or ranked at a high-trust level by the submitting user.

Hence, as there are distinctions between types of queries, the user may designate a specific trust level for enabling the query processing platform 103 to better route the request among friends-of-friends within their contact network. In keeping with the example query above, the request would be directed toward those users deemed reliable and trusted to take care of the dog. Hence, relevancy between a user and a query is based, at least in part, on profile information associated with the user or the one or more other users, a category (e.g., contact category, community category, friendship category, associated trust category or level) associated with the user or the one or more other users, a recent activity of the user or the one or more users, the one or more characteristics, or a combination thereof. The trust level or category may also be a form of context information useful for matching a potential respondent with a particular query.

Still further, in certain embodiments, “context” may also pertain to real-time or historical interactions that occur between a user and their respective UE 101. It is noted that how a person uses a device can be examined to show specific patterns that represent that user's behaviors or tendencies relative to a given activity, and hence, the activity may be placed into context. The current way in which the user interacts with their device may also provide insight into the nature of their query. For example, if the user submits a query while they are exercising on a treadmill, this activity may provide additional context information pertaining to the query for enabling it to be directed to appropriate other users. Also, by way of example, some mobile devices 101a keep records of a user's interactions with their device at given moments, such as when the user engages the device for: (1) communicating via text messaging or e-mail (e.g. through maintenance of a communication log/history); (2) playing media files or streaming data; (3) social networking; (4) using certain applications; etc. Data is recorded, therefore, as “context information,” which pertains to any data indicative of the current activity the user is engaged in with respect to the device. It is noted that the processing of matching other users to a particular query is enhanced when more context information is provided for rendering a decision.

In general, context information refers to, at least in part, all contextual data, user data and user-to-device interaction data (e.g., date, time of day, location, activity, motion, position, modality, spatiotemporal element, etc.) as collected, and is particularly useful for determining a present state or modality of the device. In addition, context information can be determined through analysis of historical data pertaining to the user or device, so as to enable a means of predicting to a degree to certainty expected or future device states or modalities. For example, if it is observed that a user frequently executes a music player during the early morning hours of the day, this information can be utilized for determining or defining a context relative to the user based on this tendency (e.g., context=workout time). Hence, the compilation of context information can be analyzed appropriately, including referenced with respect to additional data and/or a context model, for enabling the context of a device, device user or one or more other associated users and their respective devices to be determined accordingly.

By way of example, in certain embodiments, context information may also include data transmitted during an instance of device engagement with the social networking service 113 over the communication network 105. Also, by way of example, context information may pertain to any data gathered by one or more sensors 111a of the device, said data representing sensory phenomena useful for characterizing the present moment interaction between the device and one or more devices, objects or users. Exemplary sensors 111 may include, but is not limited to, a sound recorder, light sensor, global positioning system (GPS) and/or spatio-temporal detector, temperature sensor, motion sensor, accelerometer, gyroscope and/or any other device for perceiving sensory and environmental phenomena. Objects for which the device may interact may include, but is not limited to, other user devices (e.g., cell phones), peripheral devices such as Bluetooth headsets, keyboards and server devices or entities within the immediate environment or context of use such as buildings, landmarks, machines, vehicles or people.

In certain embodiments, the UE 101 may include various executable modules 105a-105e for interacting with the query processing platform 103, as well as perform one or more useful device actions relative to engaging the social networking service 113. While not shown expressly, each of the one or more UE 101a-101n may also be configured in the same fashion or alternatively, feature only some of the exemplary modules 105a-105e if any. The exemplary modules of the UE 101a include a user interface module 105a, a proximity matching module 105b, a data collection module 105c, a communication module 105d and a context determination module 105e.

The user interface module 105a, by way of example, enables presentment and personalization of the social networking service 113 to the interface of their respective UE 101 in conjunction with the query processing platform 103. Through the user interface module 105a, users can view and update their user profiles, such as by selecting the categories of queries they are interested in assisting with, visually review the history of raised questions and received answers, etc. It is noted that the user interface module 105a provides a means of interaction between the user and the various executions and features of the query processing platform 103 and social networking service 113 by way of a keyboard, virtual keypad, stylus, or other data input mechanism. Any capabilities afforded by the particular social networking service 113 may be rendered to the display of UE 101 by way of the user interface module 105a.

Operable in connection with the user interface module 105a, in accordance with an embodiment, is the communication module 105d. The communication module 105d allows users to input a query as well as select other users within their contact network to engage with. Query input is sent to the query processing platform 103 for processing, so as to determine a best fit from among the contacts of the social networking service 113 for addressing the question. In addition, the communication module 105d allows users to review query results as generated by users within the network 113. Still further, the communication module 105d enables users to input feedback data in response to a received query response. The feedback data may be provided as input in the form of a written message (e.g., user recommendation), indicated as a ranking, a rating, a user assigned score or a combination thereof.

According to an embodiment, a proximity matching module 105b determines whether the profile of a user of a UE 101b-n that is within proximity to the user of UE 101a, is contextually relevant to an inquiry posed by or stored by the user of UE 101a. In certain instances, the user of UE 101a may store a query received as input to the query processing platform 103 to temporary memory (e.g., cache) of the UE 101 for addressing the query later. The proximity matching module 105b may be configured to detect temporary short-range connections between devices within range of one another, i.e., via Bluetooth. Still further, the proximity matching module 105b can retrieve queries as stored to cache of the UE 101a for comparing it against profile information pertaining to the devices within range of it. When a match is detected, the proximity matching module 105b generates an alert to the user of UE 101a to indicate the other users of UE 101. Still further, it attempts to broadcast and forward questions to the identified matching devices to enable a communication session for receiving a response to the question. It is noted that the proximity matching module 105b, unlike the social networking service 113, provides a mechanism for unrelated users to be involved in the query response process. In this way, the ability to address a query is not limited to known or established contacts within the network only, but rather, includes any opportunistic encounters with other users that may have relevance to the query.

According to an embodiment, a data collection module of the UE 101a periodically collects the context information generated by a UE 101 associated with respective users, including information descriptive of a date, a time, a location, a relationship, an activity, device usage or a combination thereof relative to a particular user of UE 101. By way of example, if the originator of a query is a user of UE 101a and potential recipients of the query (e.g., those associated with the same social networking service 113) are users of UEs 101b-n, the status of the recipients is important for determining how to direct the query. When it is determined that the user of UE 101b is offline, for example, or that the user is presently involved in a high-priority meeting, context information pertaining to such conditions can provide guidance into the timeliness, effectiveness and overall ability of that user or device to address the submitted query. The aggregation of context information by the data collection module 105c is used, therefore, to support the context recognition and determining capabilities of a context determination module 105e. Upon receipt the UE 101 can store the collected data in, for instance, the data storage 109.

According to an embodiment, the context determination module 105e determines an actual context of the user or respective device based on the context information as gathered by the data collection module 105c. The context is characterized by context determination module 105e according to a context model. A “context model” may specify any data type definitions, associated data structures and/or schema for representing an object, interaction, event, process or combination thereof relative to the user or UE 101. In particular, the context model indicates the classifier types, identifiers and object types, associated expected input data types and the expected response or output data types for the context being modeled (e.g., a system, an event or object based context). Furthermore, the context model indicates the relationships between the data sets and data types of which it is comprised. Still further, the context model may also define one or more object-oriented, abstract or conceptual elements that in combination, characterize the behavior of an underlying system, object, interaction, event or process. It is noted that the various known approaches to generation of a context model are within the scope of the embodiments as presented. As a general approach, the context model can be designed and trained initially through various data conceptualization techniques.

It is noted that the context information collected by the data collection module 105c may be used for comparison against data maintained in a user profile and/or against the query in order to determine an extent of affinity, associated trust or relevance between a particular user context, their profile and the inquiry. In other instances, the context determination module 105e may operate in connection with the proximity matching module 105b for determining if a user of UE 101b-n within range of an inquiring user of UE 101a is suited for the addressing the query. In other instances, once the status (context) of a user deemed to be a good match to a particular query is determined to have changed, the context determination module 105c updates the query processing platform 103 accordingly—i.e., modifying which users the query is directed to based on known contextual considerations.

According to an embodiment, the communication module 105d enables a user to send (publish) and receive queries and responses to queries over the communication network 105. By way of example, the communication module 105d enables queries to be directed to one or more users within the social networking service 113. In addition, the communication module 105d executes communication logic with the query processing platform 103 for gathering data descriptive of the network, connection or forwarding path followed in propagating a query from one user to another in the process of generating a response to the inquiry.

In one embodiment, the communication module 105d and the query processing platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101, the query processing platform 103 and the social networking service 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model. By way of example, the UE 101 is operatively configured for enabling various online and network communication, including performing Internet searches, accessing network based intelligent information systems and the like.

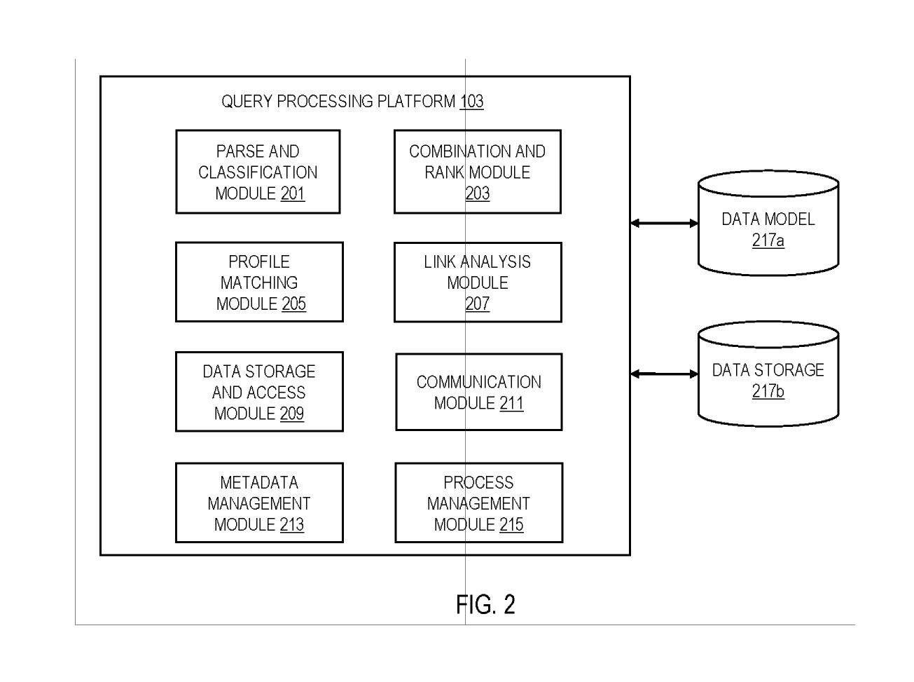

FIG. 2 is a diagram of a query processing platform for enabling an information search to be performed based on the context of the requesting user, according to one embodiment. By way of example, the query processing platform 103 includes one or more components for generating search results. It is contemplated that the functions of these components may be combined in one or more components or performed by other components of equivalent functionality. In one embodiment, the query processing platform 103 includes a parse and classification module 201 that communicates with the communication module 105d of UE 101 to receive queries as input by the user. Upon receipt of the query, the question and/or statement is parsed into its relevant keywords, which are then compared against a data model 217a for classifying the query into one or more pre-determined categories. Under this scenario, the parse and classification module 201 may be configured to employ the data model 217a for executing information retrieval and machine learning techniques. By way of example, the parse and classification module 201 can be trained according to a support vector machine, or the data model 217a may be based on an existing classifier or question-and-answer corpus for associating a category with a keyword (e.g., keyword “Egypt” may be classified according to a category of “Travel”). Generally, the parse and classification module 201 is useful for supporting the ability of the query processing platform 103 to direct queries to one or more other users accordingly.

According to an embodiment, a combination and rank module 203 combines the responses returned by the different users of UE. By way of example, the module 203 ranks the answers according to their relevance to the respective query by various metrics, i.e., as based on relevancy, freshness, popularity, trust level or other criteria. It also synthesizes the different paths representative of the propagation of queries to one or more users (each of which records one propagating route of the question) into a subgraph that describes the group of people who actually contribute to the answers. In addition, a profile matching module 205 identifies all the candidates within the users contact network, i.e., among the questioner's social networking service 113, whose profile includes or is associated with the category assigned to the query by the parse and classification module 201. The profile matching module 205 also checks the status of the identified candidates against context information of the user that submitted the query to further match and align a query with a particular responder. By way of example, if the user of UE 101 is at an airport at the time of submitting the question, global positioning data can be sensed by the data collection module 105c for determining the location based context by the context determination module 105e. The determined context can then be used to narrow the field of candidates down to those in the travel industry.

According to an embodiment, the link analysis module 207 analyzes the network position and potential social influence of the questioner's immediate contacts from among the myriad of users specified within the user's social networking service 113. By way of example, the link analysis module 207 is able to detect the extent of the relationship (e.g., trust level, social or familial relationship) between an inquirer and a potential user that will respond (e.g., a respondent) or the depth of propagation of a particular query. Under this scenario, if a query is forwarded multiple times, the linkages defining the path of propagation of the query are accounted for by the link analysis module 207. Still further, the nature of the relationships may also be analyzed for establishing a trust level associated with a given user, and likewise, a trust path for indicating the degree to which the question propagated from friend-to-friend while maintaining a specific trust level (e.g., highly trusted, trusted). The results of the link analysis module 207, i.e., a trust level, a trust path and data indicating the depth of propagation of a query, is maintained in a data store 217b for later review by a data storage and access module 209. It is noted that linkage data is maintained in the data store 217b for propagation of the query both within the network and outside of the social network. Still further, in certain instances, a forwarded query from a user associated with one social networking service 113 may be forwarded again to a user associated with an entirely different social networking service 113.

The execution of modules 201-209 enables the query processing platform 103 to account for the extent to which the profiles of the candidates match the category associated with the query, the consistency of their established contexts and the candidates' network positions and relational relevancy. In accordance with an embodiment, a communication module 211 compiles a ranked list of the candidates to whom it will direct or recommend the user to submit the queries to. In addition, the communication module 211 interfaces with the communication module 105d of the UE 101 for enabling logical processing of queries as input by the user. Logical processing may include the execution of protocols for sending and receiving questions and answers among users of the social networking service 113 over the communication network 105.

By way of example, the data storage and access module 209 stores the structured data of the entire social network of the user, the semi-structured data of user profile 115, and the current contexts of each user for enabling easy access support to the profile matching module 205 and the link analysis module 207. In accordance with an embodiment, the query processing platform 103 further includes a metadata management module 213 that stores all the descriptive data generated by respective modules 201-211. While not shown, a metadata management module may also execute on respective user equipment for supporting the processing of context information, profile information, etc.

Also, in accordance with an embodiment, the process management module 215 coordinates the interaction between the modules 201-213, providing the necessary control mechanisms for ensuring their operation relative to various UEs 101a-n. The process management module 215 controls the entire lifecycle of a question from the moment the query is submitted (published to one or more users) to being forwarded among users to the aggregation and publishing of responses. The process management module 215 also records the users who have contributed to an answer as well as maintains details regarding incentives for the contributors. Incentives may be based on a user specified timeliness factor, a scale indicative of the user's effectiveness in providing responses, a score for indicating the effectiveness of the information that was provided relative to the query, etc. Establishment of an incentive program within the context of a social networking environment provides an means of promoting timeliness and efficiency among members of the social networking service 113 while also ensuring that more valuable respondents be recognized accordingly.

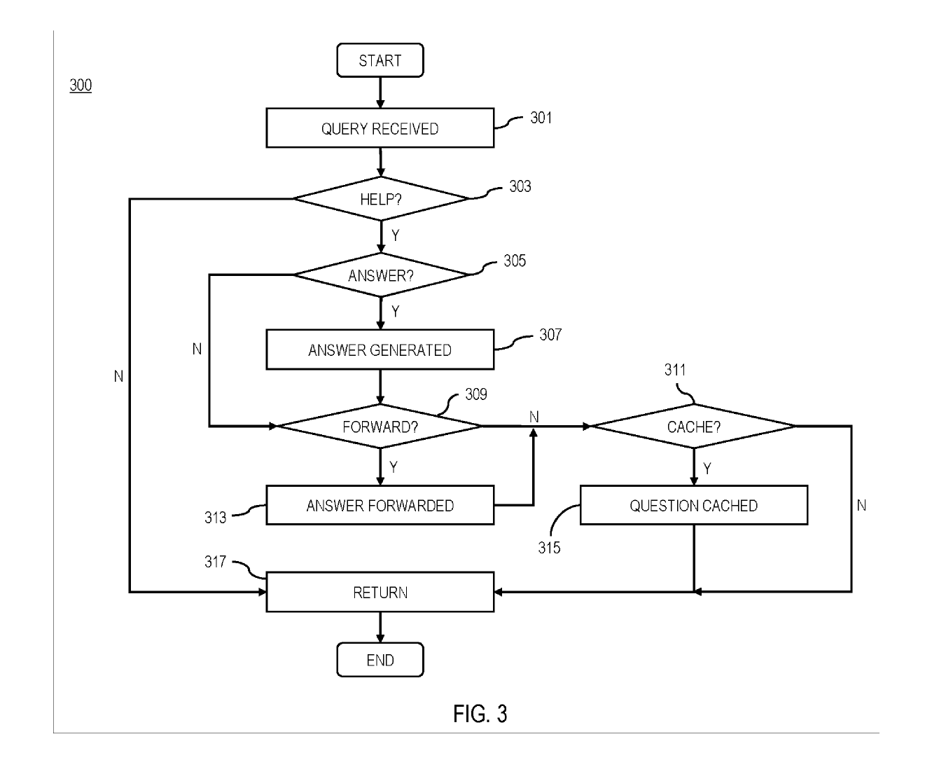

FIG. 3 is a diagram of a workflow for responding to, forwarding or caching an information search request submitted by a user, according to one embodiment. By way of example, the workflow process 300 is applicable to initial or subsequent forwarding or propagation of queries. In step 301, a query is received by the query processing platform 103 in the form of a question, statement or combination thereof, generally constructed for inquiry purposes. The query is posed, submitted or published via the query processing platform 103 among one or more users. In step 303, a user may decide to help address the query, corresponding to acceptance of the query request. Alternatively, a user can decide to dismiss/ignore the query, corresponding to step 317. In steps 305, 307 and 309, the user may decide to generate a response to the query or forward the query to temporary memory (cache), corresponding to step 311. When a response is generated, it can be forwarded to the requesting user and other users for viewing, corresponding to step 313. When the user decides to store the query for subsequent response, the question can be cached, corresponding to step 315. Once the answer is generated, as in step 313, or the question is cached, as in step 315, the execution may return, corresponding to step 317.

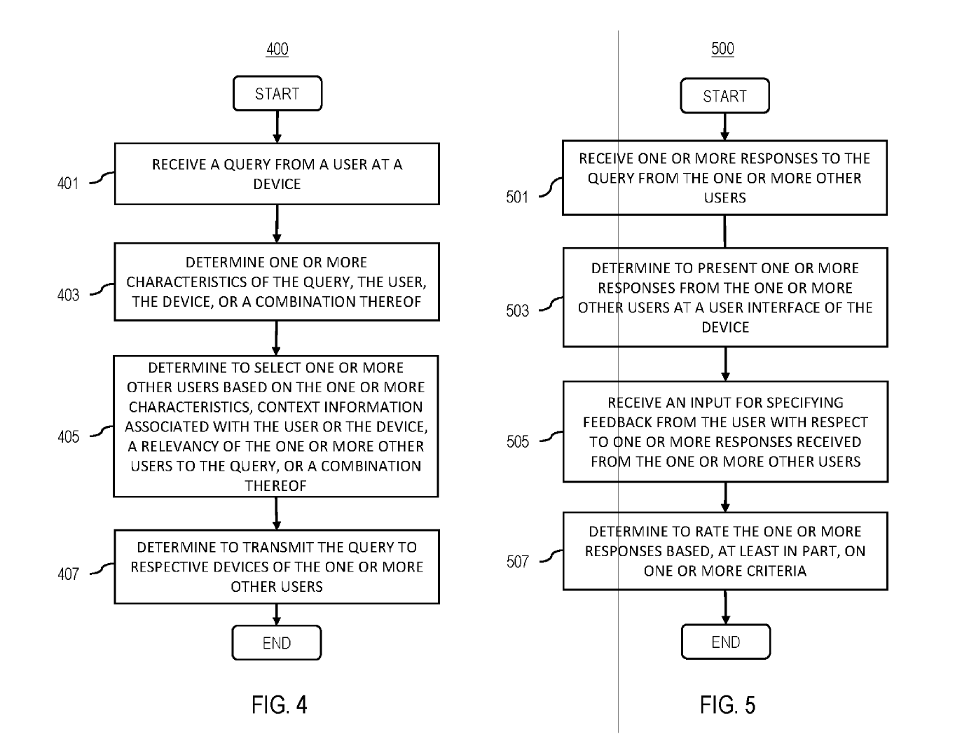

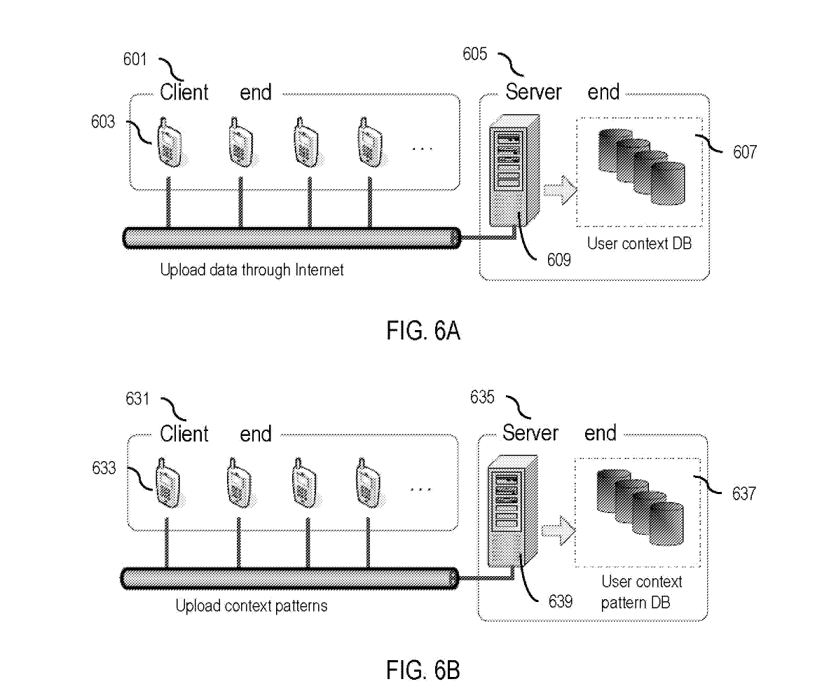

FIGS. 4 and 5 are flowcharts of a process for enabling an information search to be performed based on the context of the requesting user, according to various embodiments. In the process 400 of FIG. 4, step 401 entails a query being received by the query processing platform 103 from a user at a device. In step 403, one or more characteristics of the query, the user, the device or a combination thereof are determined. The characteristics may include a particular category to which the query belongs, a context related to the query relative to the user, etc. In step 405, the query processing platform 103 operates in connection with the social networking service 113 or with respective devices to determine to select one or more other users based on the one or more characteristics, context information associated with the user of the device, a relevancy of the one or more other users to the query, or a combination thereof. In another step 407, the query processing platform determines to transmit the query to the respective devices of the one or more other users.

In the process 500 of FIG. 5, step 501 entails receiving one or more responses to the query from the one or more other users by the query processing platform 103. In step 503, the query processing platform 103 determines to present one or more responses from the one or more other users at a user interface of the device. In another step 505, the query processing platform 103 further receives an input for specifying feedback from the user with respect to the one or more responses received from the one or more other users. In another step 507, the query processing platform 103 determines to enable a user to rate the one or more responses based, at least in part, on one or more criteria. The feedback provided by the user may be data that provides an indication of the quality of the one or more responses, the one or more other users, or a combination thereof based, at least in part, on a rating, a score, a user recommendation, a ranking, or a combination thereof.

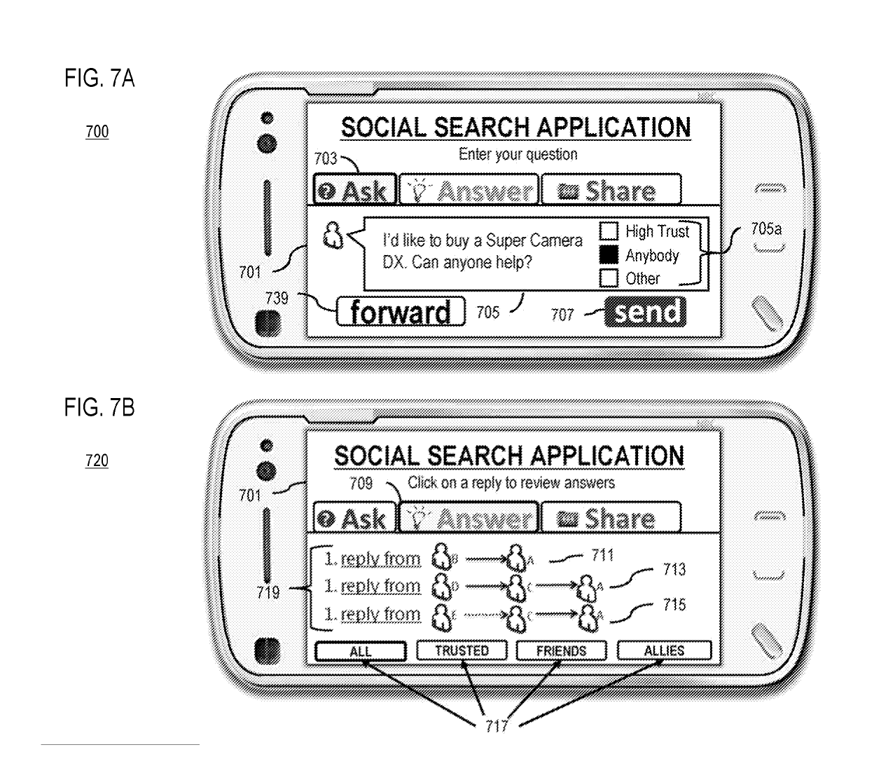

FIGS. 6A and 6B are diagrams of interactions between a client and a server utilized in data mining included in the processes of FIGS. 4 and 5, according to various embodiments. FIG. 6A shows that data such as queries retrieved at the client end 601 from mobile devices 603 (e.g., UEs 101a-101n), may be uploaded to the server end 605 through the Internet (e.g., communication network 105). In one embodiment, the server end 605 may include the query processing platform 103 and/or the social networking service 113. At the server end 605, the uploaded data is stored in the user context database 607. This embodiment is advantageous in that the mobile devices 603 can reduce their computational burdens associated with the data mining to the server 609. It is noted that the server 609 generally has more processing power and related resources (e.g., bandwidth, memory, etc.) than the mobile devices to handle this type of computation.

Alternatively, as shown in FIG. 6B, the data retrieved by the mobile devices 633 at the client end 631 may be stored at storage media (not shown) of the respective mobile devices 633. The mobile devices 633 may then locally perform the computations for determining, for instance, the context patterns from the data. Then, the result of the computation (e.g., the context patterns) may be uploaded to the server end 635 including a server 639 and user context pattern database 637. This embodiment is advantageous in that the data is kept within the respective mobile devices 633, and is not uploaded to other devices or servers without the user's permission. Thus, this embodiment in FIG. 6B provides a higher level of privacy protection. In addition, for both embodiments in FIGS. 6A and 6B, the user of the mobile device may configure a privacy setting to determine whether any data retrieved from the mobile device can be sent to the server end 635. Further, although not shown, much of the analysis of the behavior pattern according to this invention may be performed within the mobile device 633 even when the mobile device 633 is not connected to the server 639. As long as the mobile device 633 has the data and sufficient processing power to analyze the data, then the server 639 may not be required to perform the analysis.

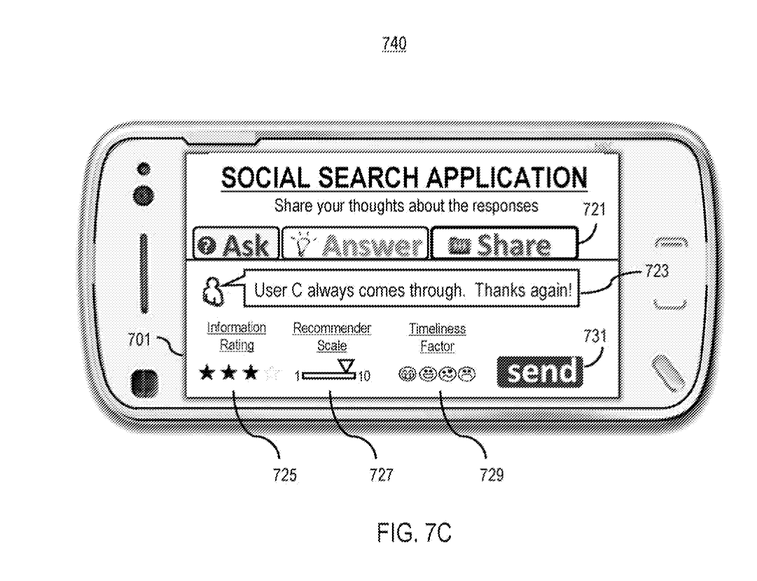

FIGS. 7A-7C are diagrams of user interfaces of a device utilized in the processes of FIGS. 4 and 5, according to various embodiments. In FIG. 7A, a device 700 features a user interface 701 for executing a social search application, i.e., as provided by way of a social networking service 113 operable in connection with the query processing application. A user may select an “Ask” tab 703 for accessing a query entry screen of the social search application. By way of example, the user enters a query 705 for requesting information about a camera purchase. The user may also indicate a trust level to associate with the query for indicating the context or nature of the query. Exemplary trust levels to associate with the query may include a “High Trust,” “Anybody” or “Other” level and may be selected by way of checkboxes 705a or other designation means. As mentioned previously, when the user selects the “High Trust” category or level in association with a query, the query is directed to only those users designated as high-trust by the user, and are designated as such within their user profile. When “Anybody” is selected, the query is directed to all users within the contact or social network as well. It is also open to being addressed by external users via a chance or opportunistic encounter. When “Other” is selected, an additional screen may be presented to the user for allowing them to enter specific tags or select additional criteria for directing the query. For example, when the query is related to traveling to Egypt, the user may enter the keyword/tag “African” for identifying friends who may be of African nationality, select an occupational category of “travel agent,” specify a particular date range to limit the query to, etc.

Once the query is formulated and the trust level for the query is designated, the user then submits the query 705 by selecting the “Send” button 707. Upon selecting the Send button 707, the query is submitted to the query processing platform 103, where the platform perform the various processes described with respect to FIGS. 4-5. It is noted that when the user selects no particular trust level or category, the system may optionally associate a default trust level with the query (e.g., Anybody). It is further noted that the query processing platform 103 is suitably configured to perform analysis of the query for determining the relative nature and/or context of the question—i.e., determining if it is asking a favor or opinion versus an inquiry or advice through use of qualitative language analysis, data modeling, etc.; then directing the query accordingly based on this determination and/or trust level derived from the determination.

In FIG. 7B, a device 720 features a user interface 701 of the social search application for enabling review of responses as submitted by one or more users to the query 705. The user of the device 720 may select an “Answer” tab 709 for accessing the responses. Upon selection, the user is presented with the one or more replies 719, presented in an order of rank, relevancy, trustworthiness, etc. In connection with each response 719, a subgraph, icons or other indicators may be featured for a representative answer for indicating the route or path through the network the query was forwarded, transmitted or propagated in order to yield the response. In addition, the transmission path may also be representative of an opportunistic encounter that occurred for yielding a response to a query. Still further, a trust path representative of the extent to which a designated trust level was maintained and/or propagated throughout to yield an answer may be indicated. An exemplary use case depicting this execution relative to FIG. 7B is discussed below.

By way of example, user A submits (publishes) a query requesting information about a camera purchase, e.g., “I'd like to buy a Super Camera DX. Can anyone help?” Upon submission, the query processing platform 103 identifies the most relevant contacts of user A's social network who may be interested, most capable, most trusted or best suited to address the query, then forwards this request to these contacts. In this case, user B and C are deemed best suited to receive this question; where the query processing platform 103 also takes into consideration various contextual details regarding user A in making the decision. Since user B is a photographer, user B sends a response to user A directly by way of the described query response process. User C, however, is not quite familiar with the query topic, so decides to forward the request to other users with user C's contact network, social network, etc. User C can initiate the forwarding process by selecting the “forward” button 739 of FIG. 7A. It is noted that this propagation process may be performed multiple times at multiple levels of depth until an answer is presented.

The query processing platform 103 then returns candidates of user C's network to whom user C should forward the originally submitted query of user A to. User C also caches this request to her mobile device while on-the-go. In this case, user D is a friend of user C, and has just bought a camera, so user D replies to the query with details. Under this scenario, as user C takes a bus to go home, user C encounters user E, a user who is not originally associated with user C's contact network. By way of short range detection sensing mechanisms on respective devices of users C and E, the query processing platform 103 identifies that user E's profile matches the cached query 705 and gives an alert to user C that user E is willing to assist. The alert may also indicate to user E that a user within proximity to them is interested in receiving a response to the query 705. User C forwards this request to user E and user E submits a response. As a result of this query 705 forwarding/response process, user A receives three replies to their originally submitted query 705 that feature the following path indications: “A-B”, “A-C-D”, and “A . . . E”, as is shown in FIG. 7B.

By way of example, “→” indicates a friendship linkage, while “-->” represents an opportunistic encounter. In FIG. 7B, response 711 is received directly from a friend (user B) of user A, while response 713 is received by way of a friend (user D) of a friend (user C). Response 715 is received by way of an opportunistic encounter (user E) of a friend (user C). It is noted that user A, in viewing the responses, can filter the list of responses by way of one or more filter options 717. Under this scenario, as the number of responses to a particular query 705 may be many, the user is able to get to their most trusted answer based on a trust level or category assigned to specific users. Filter options may include “ALL,” for viewing all responses, “TRUSTED” for viewing only the responses of the users deemed most trustworthy by the initiating user, “FRIENDS” for viewing only the responses submitted by friends (hence, no chance encounters), and “ALLIES” for viewing only the responses submitted by those outside of the initiating user's contact or social network (e.g., chance encounters). Filter categories may be indicated by the initiating user, user A, as part of the profile information they associate with respective users of their contact or social network.

In FIG. 7C, a device 740 features a user interface 701 of the social search application for enabling the initiating (e.g., user A) to give different ratings and feedback to those users who responded for indicating the usefulness of their advice. The user accesses this screen by selecting a “Share” tab 721. Upon selection, the user may enter a personalized message 723 for a particular respondent. In addition, the user may select from various ranking, rating or effectiveness indication tools. By way of example, an information rating 725 may be presented as a star rating system for indicating the initiators feelings about the efficacy of the response. A recommender scale 727, presented as a slide rule that can be toggled from 1-low to 10-high, is also provided for indicating the user's feelings about the effectiveness of the recommender. A timeliness factor 729 may also be presented to indicate how timely the response was. Once selections are made, the feedback can be shared (published) by pressing the “send” button 731, making the feedback viewable from the devices of respective individual respondents and others within the social network.

The various indicators may be compiled to determine a overall score representative of the effectiveness of the respondent. It is noted that the feedback may be used to inform/train the query processing platform 103, such as for enhancing the query processing system's ability to recommend user's best suited for addressing a query. In this way, a user's whose score tends to be higher relative to a particular query need, category or criteria, may be recommended by the system more often. It is further noted that the feedback mechanism may be useful for enabling an incentive program as established among users of the social networking service 113, as well as for forging new potential friendships with previously unknown users by encouraging opportunistic encounters surrounding a mutual task (resolving the query).

The above described processes, in certain embodiments, advantageously provide an efficient, convenient, and secure approach for facilitating an information search based on the context on a user. The system 100 leverages the collective wisdom by allowing context-specific questions and answers to be processed and forwarded among one or more users within of virtual environment (e.g., social network) or within a physical environment to provide yield information in a real-time. In addition, the exemplary process and system emphasizes the intelligent routing and propagation of information (e.g. queries) among friends and friends-of-friends. The system and processes presented herein provide a means of real-time and context specific questions and answer experience to be derived from the users who are deemed most reliable and trustable to the initiating user. As the query is propagated between friends-of-friends in a word-of-mouth manner, any propagation path can yield an answer to the question immediately, and different answers and solutions from different users can be aggregated and synthesized.

The processes described herein for enabling an information search to be performed based on the context of the requesting user may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

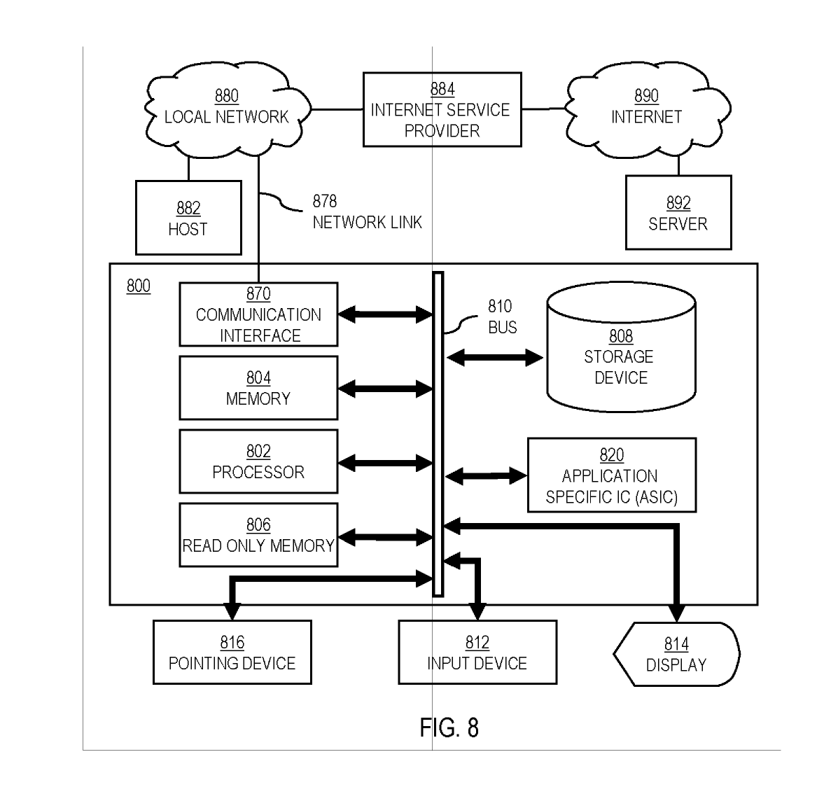

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to enable an information search to be performed based on the context of the requesting user as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of enabling an information search to be performed based on the context of the requesting user.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to enabling an information search to be performed based on the context of the requesting user. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for enabling an information search to be performed based on the context of the requesting user. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for enabling an information search to be performed based on the context of the requesting user, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for enabling an information search to be performed based on the context of the requesting user to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

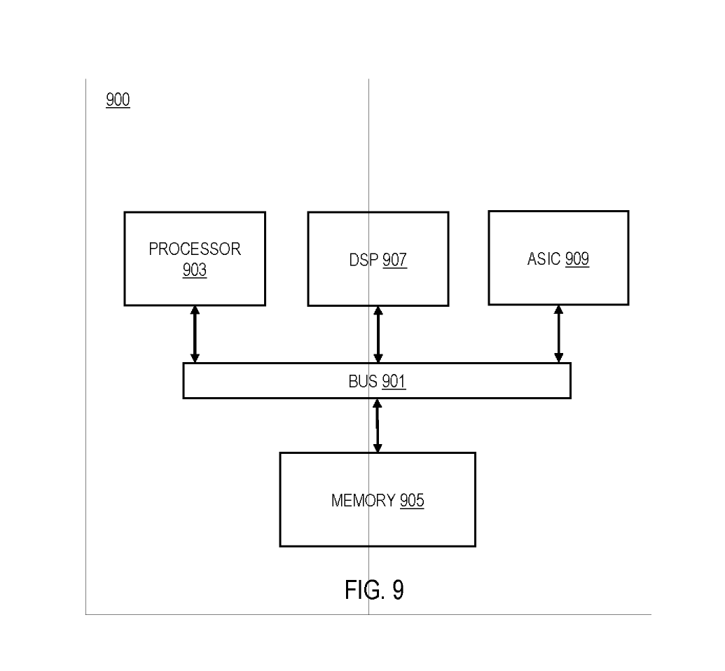

FIG. 9 illustrates a chip set or chip 900 upon which an embodiment of the invention may be implemented. Chip set 900 is programmed to enable an information search to be performed based on the context of the requesting user as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of services. Chip set or chip 900, or a portion thereof, constitutes a means for performing one or more steps of enabling an information search to be performed based on the context of the requesting user.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to enabling an information search to be performed based on the context of the requesting user. The memory 905 also stores the data associated with or generated by the execution of the inventive steps.

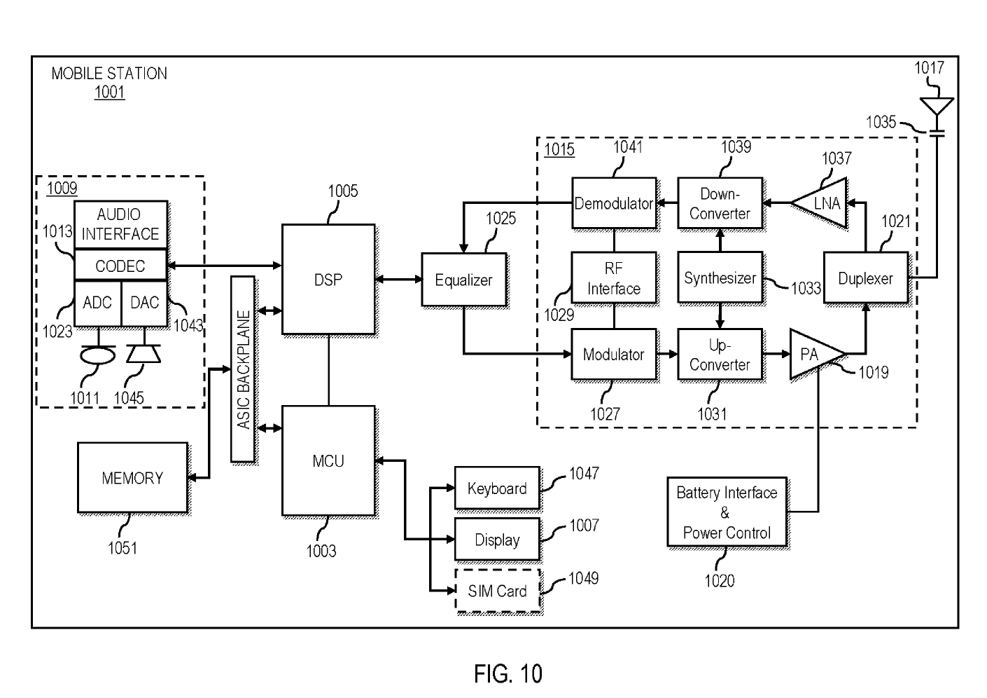

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of enabling an information search to be performed based on the context of the requesting user. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of enabling an information search to be performed based on the context of the requesting user. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to enable an information search to be performed based on the context of the requesting user. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-32. (canceled)

33. A method comprising:
receiving a query from a user at a device;
determining to select one or more other users based, at least in part, on context information associated with the user or the device, a relevancy of the one or more other users to the query, or a combination thereof; and
determining to transmit the query to respective devices of the one or more other users.

34. A method of claim 33, further comprising:
determining one or more characteristics of the query, the user, the device, or a combination thereof,
wherein the determining to select the one or more other users is further based, at least in part, on the one or more characteristics.

35. A method of claim 33, wherein the query is associated with a requested trust level, and wherein the determining to select the one or more other users is further based, at least in part, on the requested trust level.

36. A method of claim 33, further comprising:
determining one or more categories associated with the query; and
determining one or more trust levels based, at least in part, on the one or more categories,
wherein the determining to select the one or more other users is further based, at least in part, on the one or more trust levels.

37. A method of claim 33, further comprising:
receiving one or more responses to the query from the one or more other users;
determining to rate the one or more responses based, at least in part, on one or more criteria; and
determining to present the one or more responses based, at least in part, on the rating.

38. A method of claim 37, further comprising:
determining one or more trust paths corresponding to the one or more responses; and
determining to present the one or more trust paths with the respective one or more responses.

39. A method of claim 33, wherein at least one of the respective devices determines to transmit the query to one or more other devices within proximity of the at least one of the respective devices based, at least in part, on a comparison of the one or more characteristics and one or more user profiles corresponding to the one or more other devices.

40. A method of claim 33, further comprising:
receiving an input for specifying feedback from the user with respect to one or more responses received from the one or more other users.

41. A method of claim 40, wherein the feedback provides an indication of the quality of the one or more responses, the one or more other users, or a combination thereof based, at least in part, on a rating, a score, a user recommendation, a ranking, or a combination thereof.

42. An apparatus comprising:
at least one processor; and
at least one memory including computer program code,
the at least one memory and the computer program code configured to, with the at least one processor, cause the apparatus to perform at least the following,
receive a query from a user at a device;
determine to select one or more other users based, at least in part, on context information associated with the user or the device, a relevancy of the one or more other users to the query, or a combination thereof; and
determine to transmit the query to respective devices of the one or more other users.

43. An apparatus of claim 42, wherein the apparatus is further caused to:
determine one or more characteristics of the query, the user, the device, or a combination thereof,
wherein the determining to select the one or more other users is further based, at least in part, on the one or more characteristics.

44. An apparatus of claim 42, wherein the query is associated with a requested trust level, and wherein the determining to select the one or more other users is further based, at least in part, on the requested trust level.

45. An apparatus of claim 42, wherein the apparatus is further caused to:
determine one or more categories associated with the query; and
determine one or more trust levels based, at least in part, on the one or more categories,
wherein the determining to select the one or more other users is further based, at least in part, on the one or more trust levels.

46. An apparatus of claim 42, wherein the apparatus is further caused to:
receive one or more responses to the query from the one or more other users;
determine to rate the one or more responses based, at least in part, on one or more criteria; and
determine to present the one or more responses based, at least in part, on the rating.

47. An apparatus of claim 46, wherein the apparatus is further caused to:
determine one or more trust paths corresponding to the one or more responses; and
determine to present the one or more trust paths with the respective one or more responses.

48. An apparatus of claim 42, wherein at least one of the respective devices determines to transmit the query to one or more other devices within proximity of the at least one of the respective devices based, at least in part, on a comparison of the one or more characteristics and one or more user profiles corresponding to the one or more other devices.

49. An apparatus of claim 42, wherein the apparatus is further caused to:
receive an input for specifying feedback from the user with respect to one or more responses received from the one or more other users.

50. An apparatus of claim 49, wherein the feedback provides an indication of the quality of the one or more responses, the one or more other users, or a combination thereof based, at least in part, on a rating, a score, a user recommendation, a ranking, or a combination thereof.

51. A computer program product including one or more sequences of one or more instructions which, when executed by one or more processors, cause an apparatus to at least perform the steps:
receiving a query from a user at a device;
determining to select one or more other users based, at least in part, on context information associated with the user or the device, a relevancy of the one or more other users to the query, or a combination thereof; and
determining to transmit the query to respective devices of the one or more other users.

52. A computer program product of claim 51, further comprising:
determining one or more characteristics of the query, the user, the device, or a combination thereof,
wherein the determining to select the one or more other users is further based, at least in part, on the one or more characteristics.
